(19) United States
(12) Patent Application Publication
(10) Pub. No.: US 2019/0160436 A1
(43) Pub. Date: May 30, 2019

(54) REVERSE OSMOSIS MEMBRANE AND METHOD OF PROCESSING THE SAME

(71) Applicant: HONEYWELL INTERNATIONAL INC., Morris Plains, NJ (US)

(72) Inventors: Changquan QIU, Morris Plains, NJ (US); Anna LIU, Morris Plains, NJ (US); Kai HUANG, Morris Plains, NJ (US)

(21) Appl. No.: 16/320,883

(22) PCT Filed: Jul. 28, 2016
(86) PCT No.: PCT/CN2016/092056

§ 371 Date: Jan. 25, 2019

(51) Int. Cl. B01D 67/00; B01D 69/08; B01D 69/10; B01D 71/56; B01D 71/68

(52) U.S. Cl. CPC B01D 67/0006; B01D 67/0093; B01D 69/081; B01D 61/025; B01D 71/56; B01D 71/68; B01D 69/10

(57) ABSTRACT

A reverse osmosis membrane (100) and a method of processing the same are described herein. One device includes a hollow fiber membrane material (102), and a polyamide material (104) on a surface of the hollow fiber membrane material(1 02) in a lumen (106) side of the hollow fiber membrane material (102). One method includes forming the hollow fiber membrane material (102), and forming the polyamide material (104) on the surface of the hollow fiber membrane material (102) in the lumen (106) side of the hollow fiber membrane material (102).

### TECHNICAL FIELD

The present disclosure relates to reverse osmosis membranes and methods of processing the same.

### BACKGROUND

The consumption of water is continually increasing, due to, for example, population growth and industrial development. This increased water consumption, however, is resulting in (e.g., producing and/or generating) an increased amount of contaminated and/or waste water, which presents an increasing health and/or environmental threat. As such, water purification is becoming an important issue, especially in developing areas.

One approach (e.g., process) that can be used for purifying water is reverse osmosis. Reverse osmosis is a water purification (e.g., filtering) process in which pressure is used to force water through a semipermeable membrane, which removes particles from the water. Reverse osmosis can be used, for instance, to convert salt water (e.g., sea water) and/or brackish water into clean drinking water by removing the salt and other effluent materials from the water. As an additional example, reverse osmosis can be used to remove potentially harmful contaminants, such as heavy metals and/or pesticide residues, from the water.

Existing reverse osmosis membranes are typically formed in a layered, flat sheet type structure. However, such a structure may have a low packing density and/or a low surface area, which may decrease the productivity of the reverse osmosis membrane. Further, the production process for reverse osmosis membranes having such a structure may be difficult and/or complex, which may increase the cost of producing the reverse osmosis membrane.

### BRIEF DESCRIPTION OF THE DRAWINGS

FIG. 1 illustrates a cross-sectional view of the schematic structure of a reverse osmosis membrane in accordance with one or more embodiments of the present disclosure.

FIG. 2 illustrates an image of a portion of a reverse osmosis membrane in accordance with one or more embodiments of the present disclosure.

FIG. 3 illustrates a system for processing a reverse osmosis membrane in accordance with one or more embodiments of the present disclosure.

### DETAILED DESCRIPTION

A reverse osmosis membrane and a method of processing the same are described herein. For example, one or more embodiments include a hollow fiber membrane material, and a polyamide material on a surface of the hollow fiber membrane material in a lumen side of the hollow fiber membrane material. As an additional example, one or more embodiments include forming a hollow fiber membrane material, and forming a polyamide material on a surface of the hollow fiber membrane material in a lumen side of the hollow fiber membrane material.

Reverse osmosis membranes in accordance with the present disclosure can have a higher packing density and/or higher surface area than previous reverse osmosis membranes, such as, for instance, reverse osmosis membranes formed in a layered, flat sheet type structure. As such, reverse osmosis membranes in accordance with the present disclosure can have a higher productivity than such previous reverse osmosis membranes.

Further the production process for reverse osmosis membranes in accordance with the present disclosure can be easier and/or less complex than the production processes for such previous reverse osmosis membranes. As such, the cost of producing reverse osmosis membranes in accordance with the present disclosure can be lower than the cost of producing such previous reverse osmosis membranes.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

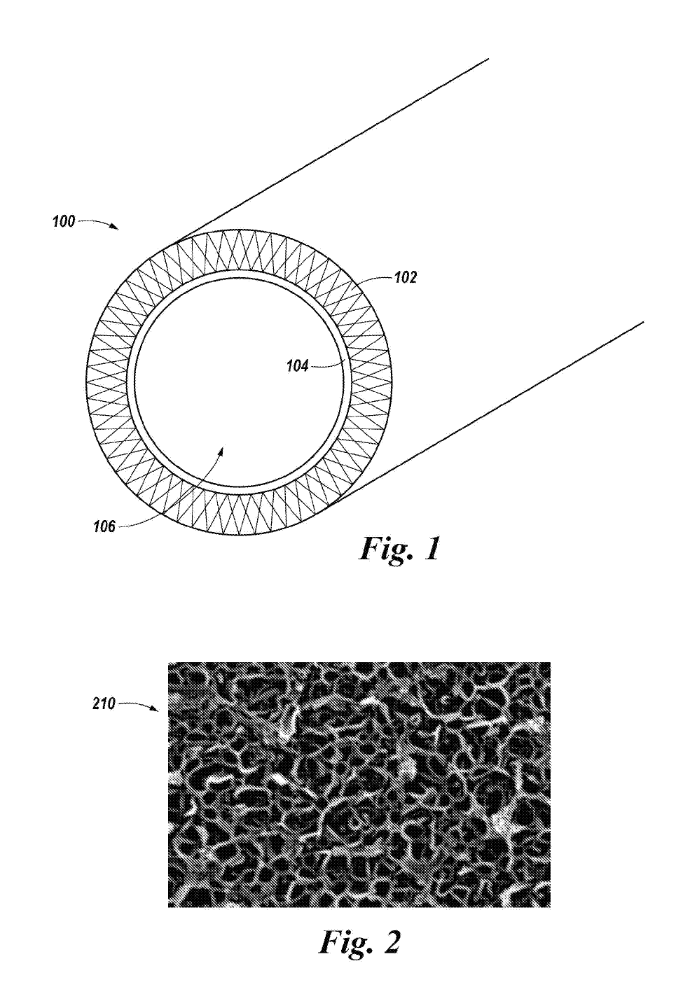

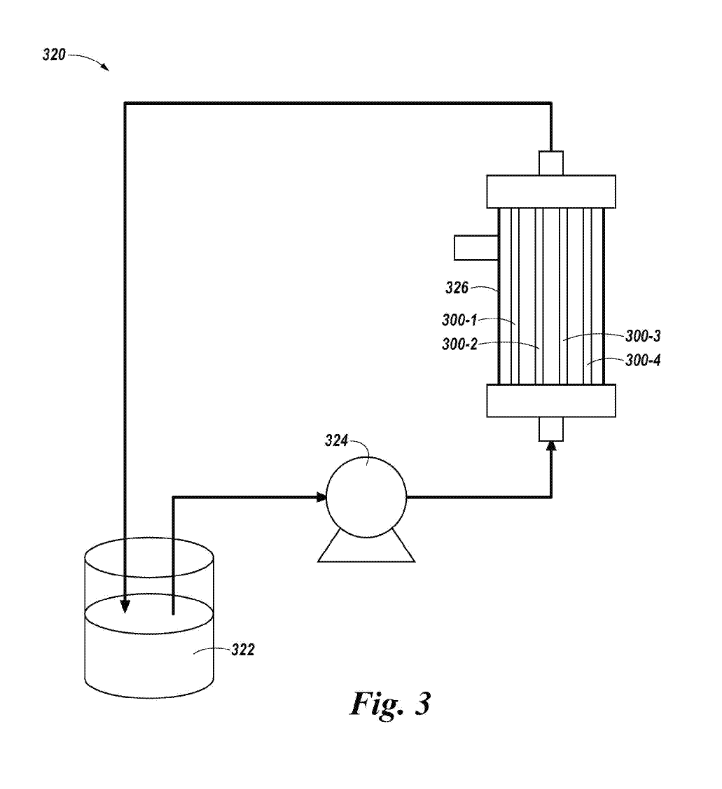

The figures herein follow a numbering convention in which the first digit or digits correspond to the drawing figure number and the remaining digits identify an element or component in the drawing. Similar elements or components between different figures may be identified by the use of similar digits. For example, 100 may reference element “00” in FIG. 1, and a similar element may be referenced as 300 in FIG. 3.

As used herein, “a” or “a number of” something can refer to one or more such things. For example, “a number of structures” can refer to one or more structures.

FIG. 1 illustrates a cross-sectional view of the schematic structure of a reverse osmosis membrane 100 in accordance with one or more embodiments of the present disclosure. Reverse osmosis membrane 100 can be part of (e.g., used in) a reverse osmosis water purification (e.g., filtering) system. For instance, pressure can be used to force water through membrane 100, and membrane 100 can remove particles from the water as it flows through the membrane, as will be appreciated by one of skill in the art. The water can be forced through membrane 100 in any direction (e.g., the direction in which the water flows through the membrane is not relevant to the filtering process).

As an example, reverse osmosis membrane 100 can be used to remove potentially harmful contaminants, such as heavy metals (e.g., arsenic, mercury, lead, cadmium, etc.) and/or pesticide residues, from the water. Further, membrane 100 can be part of a point-of-use water purification system, such as, for instance, a residential (e.g., domestic) water purification system used to filter the tap and/or drinking water of a residence. However, embodiments of the present disclosure are not limited to a particular type of use or application for membrane 100.

As shown in FIG. 1, reverse osmosis membrane can include a hollow fiber membrane material 102, and a polyamide material 104 formed on the surface of hollow fiber membrane material 102 in the lumen side (e.g., the inside, adjacent lumen 106) of hollow fiber membrane material 102. For example, fiber membrane material 102 can be formed as a hollow structure, such as, for instance, the hollow tubular structure illustrated in FIG. 1, and polyamide material 104 can be formed on the inner surface of the hollow structure formed by fiber membrane material 102, as illustrated in FIG. 1.

During a reverse osmosis water purification process that uses reverse osmosis membrane 100 (e.g. during which pressure is used to force water through membrane 100), polyamide material 104 can selectively separate contaminants, such as heavy metals and/or pesticide residues, for instance, from the water. That is, polyamide material 104 can be a selective material that can selectively separate the contaminants from the water.

Polyamide material 104 can be, for example, a cross-linked polyamide material. Further, polyamide material 104 can be a thin material as compared to hollow fiber membrane material 102 (e.g., hollower fiber membrane material 102 may be much thicker than polyamide material 104), as illustrated in FIG. 1.

Hollow fiber membrane material 102 can be a self-supporting (e.g., self-sustaining) membrane. As such, hollow fiber membrane material 102 can be the substrate for polyamide material 104 in reverse osmosis membrane 100.

Hollow fiber membrane material 102 can be, for example, a polysulfone (PSf) material, such as, for instance, PSf-1 or PSf-2. In some embodiments, the PSf material can have an m-Phenylenediamine (MPD) concentration level of 1.5 weight percent (wt. %), and a trimesoyl chloride (TMC) concentration level of 0.08 wt. %. In such embodiments, the water flux of reverse osmosis membrane 100 can be 6.0 to 6.5 Liters/m²/hour/bar (LMH/bar), which can be comparable to, or better, than the water flux of previous reverse osmosis membranes, such as, for instance, reverse osmosis membranes formed in a layered, flat sheet type structure. Because the water flux of reverse osmosis membrane 100 can be comparable to, or greater than, the water flux of such previous reverse osmosis membranes, reverse osmosis membrane 100 may be able to produce the same, or a greater, amount of purified (e.g., filtered) water than such previous reverse osmosis membranes.

Further, hollow fiber membrane material 102 can have a thickness of 170 to 210 micrometers (μm), and a porosity of 60% to 80%. Further, hollow fiber membrane material 102 can have a mean pore size of 9.5 to 12.5 nanometers (nm), and a water flux of 265 to 290 LMH/atm. Further, the inner diameter of hollow fiber membrane material 102 (e.g., the diameter of lumen 106) can be 900 to 1,000 μm.

Hollow fiber membrane material 102 can be formed, for example, using a phase inversion process. For instance, in embodiments in which hollow fiber membrane material 102 is a PSf material, the polymer material can be extruded through a spinneret in a nitrogen environment, with water flowing into the nozzle of the spinneret at a rate of 20 milliliters per minute (mL/min) to act as the bore former.

Once hollow fiber membrane material 102 has been formed, polyamide material 104 can be formed on the surface of hollow fiber membrane material 102 in the lumen side (e.g., the inside, adjacent lumen 106) of hollow fiber membrane material 102, as illustrated in FIG. 1. Polyamide material 104 can be formed on the surface of hollow fiber membrane material 102 using, for example, an interfacial polymerization process. The interfacial polymerization process can include, for instance, reacting polyfunctional amines with polyfunctional acid chlorides on the surface of hollow fiber membrane material 102 in the lumen side of hollow fiber membrane material 102. An example of such an interfacial polymerization process, and a system for performing such an interfacial polymerization process, will be further described herein (e.g., in connection with FIG. 3).

In contrast to reverse osmosis membranes of the present disclosure (e.g., membrane 100 illustrated in FIG. 1), previous reverse osmosis membranes may be formed in a layered, flat sheet type structure (e.g., instead of the hallow structure of membrane 100 illustrated in FIG. 1). For instance, previous reverse osmosis membranes may include a nonwoven fabric layer at the bottom, a thin polyamide layer at the top, and a less porous, dense polymeric layer in the middle to support the polyamide layer.

Such previous layered, flat sheet type reverse osmosis membranes, however, may have a lower packing density and/or lower surface area than hallow structure reverse osmosis membranes, such as membrane 100, in accordance with the present disclosure. As such, previous layered, flat sheet type reverse osmosis membranes may have a lower productivity than hallow structure reverse osmosis membranes in accordance with the present disclosure.

Further, the production process for such previous layered, flat sheet type reverse osmosis membranes can be more difficult and/or more complex than the production processes for hallow structure reverse osmosis membranes in accordance with the present disclosure, such as, for instance, the process further described herein in connection with FIG. 3. As such, the cost of producing such previous layered, flat sheet type reverse osmosis membranes can be greater than the cost of producing hallow structure reverse osmosis membranes in accordance with the present disclosure.

FIG. 2 illustrates an image 210 of a portion of a reverse osmosis membrane in accordance with one or more embodiments of the present disclosure. Image 210 shown in FIG. 2 is a scanning electron microscope (SEM) image of the portion of the reverse osmosis membrane.

The portion of the reverse osmosis membrane shown in image 210 can be, for example, a portion of reverse osmosis membrane 100 previously described in connection with FIG. 1. For instance, the image 210 can be a view of a portion of the surface of reverse osmosis membrane 100 in the lumen side of reverse osmosis membrane 100. That is, the image 210 can be a view of a portion of the surface of polyamide material 104 after being formed on the inside surface of hollow fiber membrane material 102.

The polyamide material illustrated in FIG. 2 can be a selective material that can selectively separate the contaminants from the water, as previously described herein (e.g., in connection with FIG. 1). Further, the polyamide material illustrated in FIG. 2 can be a thin, cross-linked polyamide material, as illustrated in FIG. 2 and previously described herein (e.g., in connection with FIG. 1).

FIG. 3 illustrates a system 320 for processing a reverse osmosis membrane in accordance with one or more embodiments of the present disclosure. For example, system 320 can be used to process (e.g., form and/or fabricate) reverse osmosis membrane 100 previously described in connection with FIG. 1. For instance, in the example illustrated in FIG. 3, four reverse osmosis membranes 300-1, 300-2, 300-3, and 300-4, each of which may be analogous to reverse osmosis membrane 100, are being processed (e.g, concurrently) using system 320. However, embodiments of the present disclosure are not limited to a particular number of reverse osmosis membranes that can be processed concurrently using system 320.

As shown in FIG. 3, system 320 can include a reservoir 322, a pump 324, and a hollow fiber module 326. Reservoir 322 can include (e.g., hold) various liquids (e.g., solutions) during the processing of reverse osmosis membranes 300-1, 300-2, 300-3, and 300-4, as will be further described herein. Pump 324 can be, for example, a peristaltic pump, and can be used to pump the liquids from reservoir 322 to (e.g., through) hollow fiber module 326 during the processing of reverse osmosis membranes 300-1, 300-2, 300-3, and 300-4, as will be further described herein.

Hollow fiber module 326 can include (e.g., hold) a number of hollow fiber membrane materials. For instance, in the example illustrated in FIG. 3, hollow fiber module 326 is holding four hollow fiber membrane materials, each of which may correspond to a different one of reverse osmosis membranes 300-1, 300-2, 300-3, and 300-4. That is, each of the four hollow fiber membrane materials in hollow fiber module 326 can be analogous to hollow fiber membrane material 102 previously described in connection with FIG. 1, and can be formed using a phase inversion process, as previously described in connection with FIG. 1.

System 320 can be used to form a polyamide material on the surface of each respective hollow fiber membrane material in hollow fiber module 326, in the lumen side of each respective hollow fiber membrane material. For example, system 320 can form the polyamide material on the surface of each respective hollow fiber membrane material in the lumen side of each respective hollow fiber membrane material using an interfacial polymerization process that includes reacting polyfunctional amines with polyfunctional acid chlorides on each respective surface. The polyamide material formed on each respective surface can be analogous to polyamide material 104 previously described in connection with FIG. 1.

As an example, reservoir 322 may be initially filled with an amine solution. Pump 324 can pump the amine solution from reservoir 322 through hollow fiber module 326, such that the lumen of each respective hollow fiber membrane material in hollow fiber module 326 is filled with the amine solution and the amine solution comes in contact with (e.g., soaks) the lumen-side surface of each respective hollow fiber membrane material. The amine solution can remain in the lumen of each respective hollow fiber membrane material, in contact with the lumen-side surface of each respective hollow fiber membrane material, for two to four minutes, for instance.

The amine solution may then be removed from the lumen of each respective hollow fiber membrane material. For example, the amine solution in reservoir 322 may be replaced with an organic solvent, such as, for instance, hexane, and pump 324 can pump the organic solvent from reservoir 322 through hollow fiber module 326 to remove the excess amine solution from the lumen of each respective hollow fiber membrane material in hollow fiber module 326, leaving only the amine solution that is in contact with the lumen-side surface of each respective hollow fiber membrane material.

After the excess amine solution has been removed from the lumen of each respective hollow fiber membrane material, the organic solvent in reservoir 322 may be replaced by an acid chloride solution, and pump 324 can pump the acid chloride solution from reservoir 322 through the lumen of each respective hollow fiber membrane material in hollow fiber module 326. As the acid chloride solution flows through the lumen of each respective hollow fiber membrane material, the acid chloride solution can react with the remaining amine solution that is in contact with the lumen-side surface of each respective hollow fiber membrane material to form the polyamide material on the lumen-side surface of each respective hollow fiber membrane material.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A reverse osmosis membrane, comprising:
a hollow fiber membrane material; and
a polyamide material on a surface of the hollow fiber membrane material in a lumen side of the hollow fiber membrane material.

2. The reverse osmosis membrane of claim 1, wherein the hollow fiber membrane material is a fiber membrane material formed as a hollow structure.

3. The reverse osmosis membrane of claim 1, wherein the polyamide material is a cross-linked polyamide material.

4. The reverse osmosis membrane of claim 1, wherein the hollow fiber membrane material is a polysulfone material.

5. The reverse osmosis membrane of claim 4, wherein:
the polysulfone material has an m-Phenylenediamine (MPD) concentration level of 1.5 weight percent (wt. %); and
the polysulfone material has a trimesoyl chloride (TMC) concentration level of 0.08 wt. %.

6. The reverse osmosis membrane of claim 1, wherein the hollow fiber membrane material is a self-supporting membrane.

7. The reverse osmosis membrane of claim 1, wherein the hollow fiber membrane material has a thickness of 170 to 210 micrometers.

8. The reverse osmosis membrane of claim 1, wherein the lumen of the hollow fiber membrane material has a diameter of 900 to 1,000 micrometers.

9. The reverse osmosis membrane of claim 1, wherein the hollow fiber membrane material is a porosity of 60% to 80%.

10. A reverse osmosis membrane comprising:
a fiber membrane material formed as a hollow structure; and
a polyamide material on an inner surface of the hollow structure.

11. The reverse osmosis membrane of claim 10, wherein the hollow structure is a hollow tubular structure.

12. The reverse osmosis membrane of claim 10, wherein the fiber membrane is a substrate for the polyamide material.

13. The reverse osmosis membrane of claim 10, wherein the polyamide material is a selective material configured to selectively separate contaminants from water.

14. The reverse osmosis membrane of claim 10, wherein the reverse osmosis membrane is part of a reverse osmosis water purification system.

15. A method of processing a reverse osmosis membrane, comprising:
forming a hollow fiber membrane material; and
forming a polyamide material on a surface of the hollow fiber membrane material in a lumen side of the hollow fiber membrane material.

16. The method of claim 15, wherein the method includes forming the polyamide material on the surface of the hollow fiber membrane material in the lumen side of the hollow fiber membrane material using an interfacial polymerization process.

17. The method of claim 16, wherein the interfacial polymerization process includes reacting polyfunctional amines with polyfunctional acid chlorides on the surface of the hollow fiber membrane material in the lumen side of the hollow fiber membrane material.

18. The method of claim 16, wherein the interfacial polymerization process includes:
filling the lumen of the hollow fiber membrane material with an amine solution;
removing the amine solution from the lumen by pumping an organic solvent through the lumen; and
pumping an acid chloride solution through the lumen after removing the amine solution from the lumen.

19. The method of claim 18, wherein the method includes:
filling the lumen of the hollow fiber membrane material with the amine solution by pumping the amine solution through the lumen using a peristaltic pump;
pumping the organic solvent through the lumen using the peristaltic pump; and
pumping the acid chloride solution through the lumen using the peristaltic pump.

20. The method of claim 18, wherein the organic solvent is hexane.
